(19) United States
(12) Patent Application Publication
(10) Pub. No.: US 2018/0033047 A1
(43) Pub. Date: Feb. 1, 2018

(54) Digital Item Transforms into Advertising

(71) Applicant: Lee M. DeGross, Fort Lee, NJ (US)

(72) Inventor: Lee M. DeGross, Fort Lee, NJ (US)

(21) Appl. No.: 14/744,027

(22) Filed: Jun. 19, 2015

(51) Int. Cl. G06Q 30/02

(52) U.S. Cl. CPC G06Q 30/0264

(57) ABSTRACT

A digital process of a computer (10) presenting an item and at or after a preset time, the item transforms or morphs into an advertisement. The item is preferably non-advertising. Alternatively a user selects the item and it transforms into an advertisement. Since the user chooses to select the item that transforms into the advertisement, the user's full and undivided attention is captured. The item can be characters, images, sounds, or non-advertising marketing information (FIG. 2). The item mitigates or prevents annoying advertisings displayed right away, and appeases users who dislike advertisements. The item that transforms is different in terms of function, content, or appearance from the advertisement (after the transformation). The transformation acts as one piece. The transformation can be presented in entertaining, fun, or surprising ways to more fully capture the user's attention. The purpose is to generate significant digital advertising revenue.

### CROSS-REFERENCE TO RELATED APPLICATIONS

This application claims the benefit of provisional patent application Ser. No. 62/014,128, filed 2014 Jun. 19 by the present inventor, which is incorporated by reference.

### FEDERALLY SPONSORED RESEARCH

Not applicable

### SEQUENCE LISTING OR PROGRAM

Not applicable

### BACKGROUND

### Field

This application relates to the field of computers, specifically to digital advertising processes.

### Prior Art

A primary goal of advertisements, regardless of the media type, is to be seen and heard as often as possible. Maximum exposure of prior art advertisements is the norm. To withhold an advertisement from view and hearing is counterintuitive. Efforts to withhold and mitigate an advertisement's exposure are almost non-existent. Therefore, very little prior art is available regarding the withholding of advertising content from view and hearing. Yet, a brief discussion is warranted to describe the closest prior art to this application.

The internet is an arena where generating sufficient advertising revenue is a major concern. The computer, software, and intranet products and services separate from the internet also have this same problem with advertising revenue.

The prior art digital advertisements are shown like a print ad. The digital advertisements come in the form of buttons, banners, and windows of various sizes with their messages displayed right away. Many of these advertisements explode into a larger size or go to an entire screen. The end result of these advertisements displayed right away is a lot of visual clutter and distraction.

There are digital advertisements displayed right away called interstitials that behave like a television commercial by being the main focus of a page. Another type of interstitial ad acts like a flyer by inserting themselves between, behind, or in front of windows. They disappear when a “close” button is selected, for example. The interstitial ads displayed right away are annoying because they are unasked for and often block the contents of the screen. They also add to the visual clutter and distraction.

A disadvantage of digital advertising displayed right away is that their annoying, distracting visual clutter is an unwelcome imposition for users who don't like such advertising. Since digital advertisings are displayed right away, another disadvantage is that they are not exposed in fun, entertaining and surprising ways.

Another disadvantage is that earning digital advertising revenue is difficult. This is because the impression rates and click-through rates of digital advertising displayed right away are significantly less than, for example, print and television advertising rates.

A solution is needed to expose digital advertising in innovative, unusual, unexpected, fun, and surprising ways to attract or capture greater user attention to generate higher revenues.

My own patent application Ser. No. 10/022,627 (2001) describes a digital blocking image, such as a door, that operates when a user selects it. The door opens to reveal the advertisement beneath. However the process requires the two parts of the digital blocking image, and the advertisement beneath. Further, to operate, it is solely dependent on a user selection, and the user may ignore and not select the blocking image altogether.

This concludes the prior art section.

### Advantages

Several advantages of one or more embodiments are the often annoying and distracting digital advertisements is largely mitigated or altogether prevented, and to pacify and appease users who don't like advertisements, and to reduce visual clutter on a screen. Other advantages of one or more embodiments are, after a preset time an item transforms into an advertisement in surprising, innovative, fun, and entertaining ways. In another embodiment the transformation occurs only if the user wants with a selection. Since the user chooses to select the item that transforms into the advertisement, the exposure is more effective because the user's full and undivided attention is captured. The advantage resulting from this high quality user attention is greater digital advertising revenues. These and other advantages of one or more embodiments will become apparent from a consideration of the ensuing description and accompanying drawings.

### SUMMARY

A digital process utilizing a computer that presents items such as images, words, and music that transforms or morphs into an advertisement. The transformation can occur after a preset time or can occur when a user selects the item. The advertisement, at its conclusion, can transform back to the original item, be replaced by a different item, or be removed altogether. The transformation is meant to be presented in entertaining, innovative, fun, and surprising ways. The intent is to generate significant digital advertising revenues.

### DRAWINGS—FIGURES

FIG. 1 shows a computer.

FIG. 2 shows presented on a screen the five items of images, characters or words, a moving image and its signal.

FIG. 3 shows, after a user selected an item or after a preset time, four of the items had each transformed into four ads, respectively.

FIG. 4 shows, after the four ads of FIG. 3 had concluded, the first ad had transformed back to its image item of FIG. 2. The second ad from FIG. 3 continues to play, or displays the advertiser's identifying information. The third ad of FIG. 3 had been replaced by a different sixth item. The fourth ad of FIG. 3 was removed altogether.

DRAWINGS -- Reference Numerals

| | | | |
|---|---|---|---|
| 10 | computer | 12 | screen |
| 14 | central processing unit | 16 | keyboard |
| 18 | mouse | 20 | selection pointer |

| | |
|---|---|
| 22 | digital contents on the screen of part 12 |
| 24a | item is a non-advertising image that is being selected by |
| | the selection pointer of part 20 |
| 26a | item is characters or words |
| 28a | item is a moving image |
| 30 | a signaling item placed next to the moving image of part |
| | 28a |
| 31a | item is a non-advertising intellectual property, trade dress, |
| | or marketing information. The item partially shows its |
| | advertisement. |
| 24b | after the selection, the item of part 24a had transformed |
| | into an advertisement |
| 26b | at or after a preset time, the item of part 26a had |
| | transformed into an advertisement |
| 28b | at or after a preset time, the item of part 28a had |
| | transformed into an advertisement |
| 31b | at or after a random preset time, the item of part 31a had |
| | transformed into an advertisement |
| 24aa | after the advertisement of part 24b had concluded, the |
| | redisplayed item of part 24a |
| 26c | after the advertisement of part 26b had concluded, some or |
| | all of it continues to display or the advertiser's identifying |
| | information is displayed |
| 29 | after the advertisement of part 28b had finished, a different |
| | sixth item of an image replaced part 28b. The signaling |
| | item of part 30 is nearby. |
| 31c | after the end of the advertisement of part 31b, an empty |
| | or blank space indicating the advertisement of part 31b |
| | had been removed |

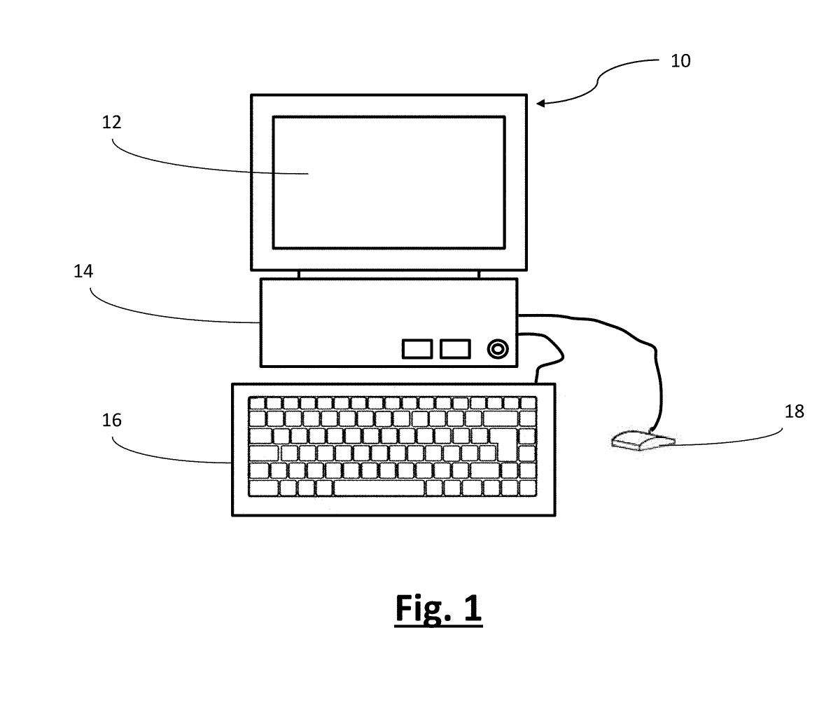

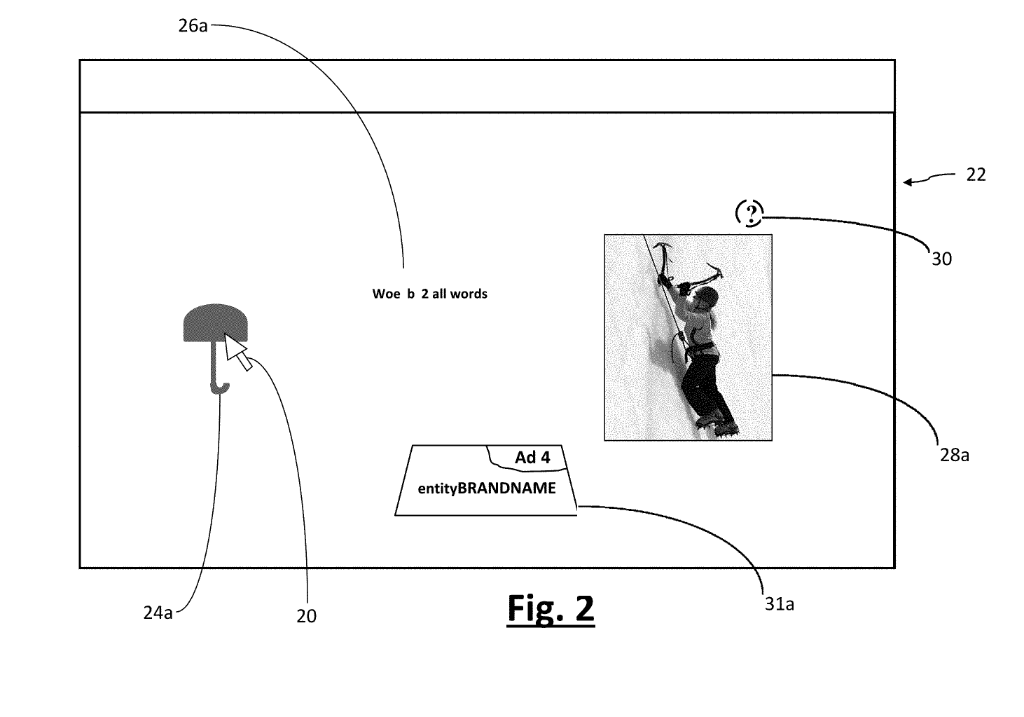

### DESCRIPTION—FIRST EMBODIMENT—FIGS. 1-2

This disclosure sets forth a computer, internet, intranet, or digital advertising process, method, and system. The purpose of the process is to generate significant digital advertising revenue. The process begins with a computer presenting an item.

First a static physical description of the computer 10, the internet, and the intranet will be discussed. The computer is a ubiquitous machine that has undergone constant changes in form, speed, and memory size and this will continue as computers evolve presently and in the future. Computers come in all shapes and sizes but share four essential characteristics consisting of the input, processing, memory, and output functions.

Peripheral devices can be added to a computer such as external hard drives, external speakers, scanners, fax machines, and external video recorders (not shown).

The selection methods and devices of a computer includes and are not limited to a keyboard 16, mouse 18, touchscreen, touchpad, touch-button, stylus, voice recognition, voice activated selection, and other such inputs. The inputs can move a pointer or cursor on the screen 12 to select, point, draw, and other such functions. FIG. 1 shows a computer 10 with its screen 12, central processing unit 14, keyboard 16, and mouse 18.

Some computers such as desktops, laptops, tablets, ereaders, watches, phones, and PDA's are segments of a broader computer system because they have one or more limited or partial computer components. The segments can entirely lack one or more computer components. The components or devices includes and is not limited to CPUs, hard drives, monitors, screens, memories, keyboards, mouse 18, computer readable media, batteries, and internet connectivity. The components can be detachable. The detached components can be attached to another computer (not shown).

Virtually all computers can access the internet and an intranet, often by wireless means (not shown).

The internet and the intranet will now be described. The idea of the internet is simple, a vast network of computers of many types that are connected and interact with one another. The whole of the internet could probably be written about in a series of large books. The following brief definition of the internet is from the IBM Dictionary of Computing. It defines the internet as, “A wide area network connecting thousands of disparate networks in industry, education, government, and research. The Internet network uses TCP/IP as the standard for transmitting information.”

The TCP/IP is defined by the same dictionary as, “Transmission Control Protocol/Internet Protocol. A set of communication protocols that support peer-to-peer connectivity functions for both local and wide area networks.”

The internet spans many countries, consists of thousands of networks, has millions of users, and will continue to grow and improve. The most relevant feature regarding the internet is the World Wide Web (WWW), with its ability to handle graphics, multimedia, and hypertext links.

The process is not limited to the WWW, and can be implemented on internet sites or networks without the WWW. It can also utilize and be implemented on internet/television hybrids (not shown).

The process can be implemented on intranet sites. The following definition of the intranet is from the Dictionary of Computer and Internet Terms. It defines the intranet as, “the opposite of INTERNET, a network confined to a single organization (but not necessarily to a single site). Intranets often include web pages, so a web browser can be used to view the content. This makes the intranet appear just the same as part of the World Wide Web, the only difference is that it is not accessible to those outside the organization. Keeping it separate from the outside world is essential if it carries confidential data, such as internal business records.”

The process is also applicable to computers and software applications that are independent of or offline of the internet, the intranet, and any other network.

The process is not limited as to the type of computer on which it runs, and is not limited as to the type of network used. This concludes the basic description of the computer hardware, the internet, and the intranet.

Next is the static description of the items presented by a computer 10. In the first embodiment, the item is not an advertisement, advertising, ad, or commercial. The non-advertising items can be in any size and in any shape. The items can be accompanied by sound effects. The items can enlarge or explode to a larger item. The item can enlarge a portion of itself.

The non-advertising items includes and is not limited to images such as illustrations, drawings, graphics, comics, comic strips, pictures, photographs, paintings, charts, maps, image hypertext links, diagrams, and computer generated images.

Further non-advertising the items includes and is not limited to moving images such as animations, claymations, stop-action imagery, cartoons, moving image hypertext links, films, motion pictures, videos, digital videos, movies, television shows, theater shows, internet shows, live action shows, and computer generated action imagery.

Further the non-advertising items includes and is not limited to characters, letters, numbers, symbols, words, sentences, quotations, text, paragraphs, pages, and textual hypertext links.

Further the non-advertising items includes and is not limited to just only sounds that includes and is not limited to digital noises, audio, voices, music, and other sound only effects. The sound or audio only items can be played separate and independent of a screen (not shown).

Further the non-advertising items can be touch or tactile items. Examples include and are not limited to touch text, touch images, touch screens, touch materials, touch surfaces, touch buttons, and Braille languages (not shown).

A signaling feature item can be placed on items or next to items. The signal item can represent sound only items. The signal indicates or denotes that the items have the transformative process, as described below in the Operation and Alternative Embodiments sections. The signal can have distinctive and special features. For example, it can have a distinguishing and unique motion.

In FIG. 2 there are four items in the first embodiment. The first item is a non-advertising image item being selected by a selection pointer 20. The second item consists of words, a letter character, and a numerical character in “Woe b 2 all words”. The third item is a moving image 28a item and the fourth item is a signal item placed nearby.

The items can be interpreted with text-to-speech/Braille, image-to-speech/text/Braille, moving image-to-speech/text/Braille, audio-to-speech/text/Braille, or touch-to-speech/text/Braille methods (not shown).

The items can be presented anywhere on the screen and at anytime. The items can have, for example, control knobs, buttons, or levels. These control functions includes and are not limited to enabling the user to pause, play, replay, stop, fast forward, rewind, playback, enlarge, shrink, rotate, magnify, translate, and adjust the sound effects. The control functions further captures the user's full and undivided attention (not shown).

### Operation—FIGS. 2-4

The first embodiment operates when a user selects the item. The item then transforms, metamorphoses, transfigures, transmutes, changes, alters, shapeshifts, or morphs into an advertisement. The item that transforms into is different in terms of function, content, and appearance from the after transformation advertisement. The transformation acts as one piece or as one part. The transformation can be catchy, surprising, fun, unusual, entertaining, and creative which can more fully capture the user's attention. Since the user selects the item that transforms into the advertisement, the user's full and undivided attention is captured.

The transformations can be lengthy and can have 2 or more acts. For example, it shows from several viewpoints the animated steps of putting on and folding a tie (not shown).

Next is the static description of the advertisement after the transformation. The advertisement can include and is not limited to characters, words, text, illustrations, graphs, pictures, photographs, animations, stop action, claymation, computer generated graphics, videos, moving advertising, and commercials. The advertisement can be a sound only advertising and can be a touch advertising.

The advertisement can be in the form of ad buttons, banner ads, ad icons, ad frames, and ad windows. The advertisement is usually rectangular but can be in any shape. The advertisement can be any size from a small icon to the entire screen. The advertisement can enlarge or explode to a larger space. The advertisement can enlarge a portion of its contents. The advertisement can be run with sound effects.

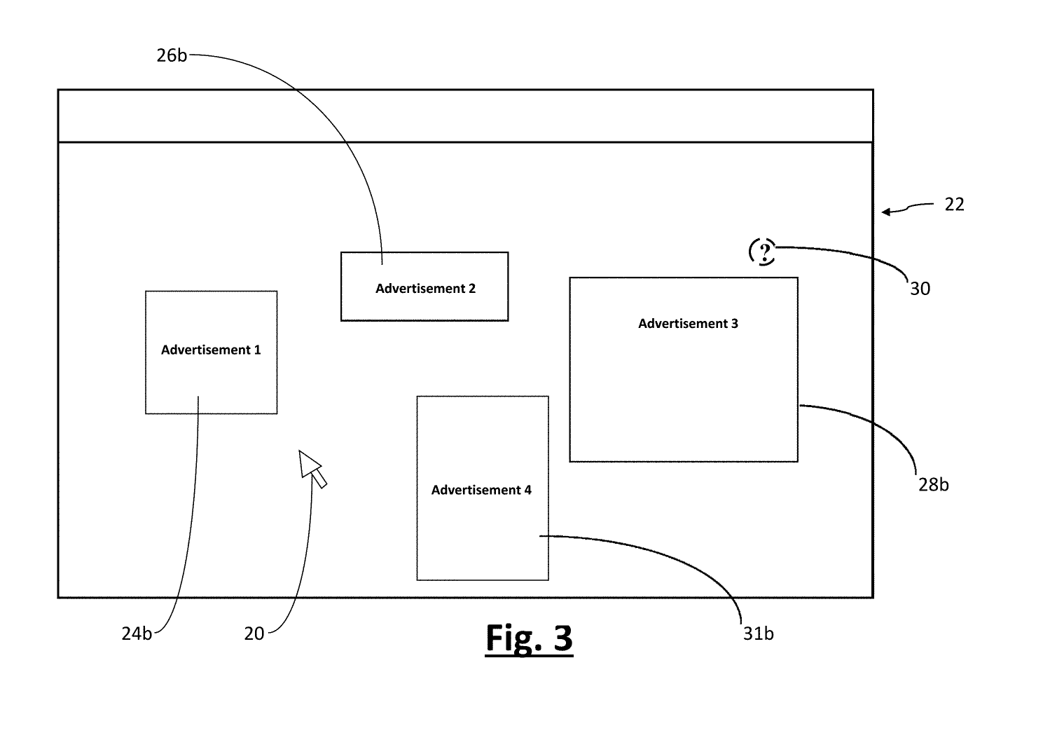

FIG. 3 shows after the selection, the first item of FIG. 2 had transformed into an advertisement.

If a user selects any viewable item, it can transform into an advertisement, a sound only advertisement, or a touch advertisement. If a user selects a signal item representing a sound only item, it can transform into an advertisement, a sound only advertisement, or a touch advertisement. If a user selects a touch item, it can transform into an advertisement, a touch advertisement, or a sound only advertisement (not shown).

The advertisements can be interpreted with text-to-speech/Braille, image-to-speech/text/Braille, moving image-to-speech/text/Braille, audio-to-speech/text/Braille, or touch-to-speech/text/Braille methods (not shown).

The advertisements can have, for example, control knobs, buttons, or levels. These control functions includes and are not limited to enabling the user to pause, play, replay, stop, fast forward, rewind, playback, enlarge, shrink, rotate, magnify, translate, and adjust the sound effects. The control functions further captures the user's full and undivided attention (not shown).

After the advertisement finishes, ends, or concludes, the advertisement can transform back to the original item again. This has several benefits. A benefit is that visual clutter is reduced. Instead of having the advertiser glare its annoying stuff on the screen, the tranquil item is shown again. Another benefit is that the user can select the item again in order to see a repeat of the advertisement for any number of reasons.

One such reason is that the user did not recall something such as the advertiser's product name and wants to find out. Another reason is that the user deems the advertising spot especially amusing and wants to view it again. Still another reason is that the user wants to know a detail from the advertisement, like a telephone number and double-checks with another selection to present the advertisement again.

In these repeat selections, the advertisement gets another high value click-through “impression” (to use internet terminology) and garners the user's undivided attention. The repeat click-throughs are a benefit because it helps to generate additional digital advertising revenue.

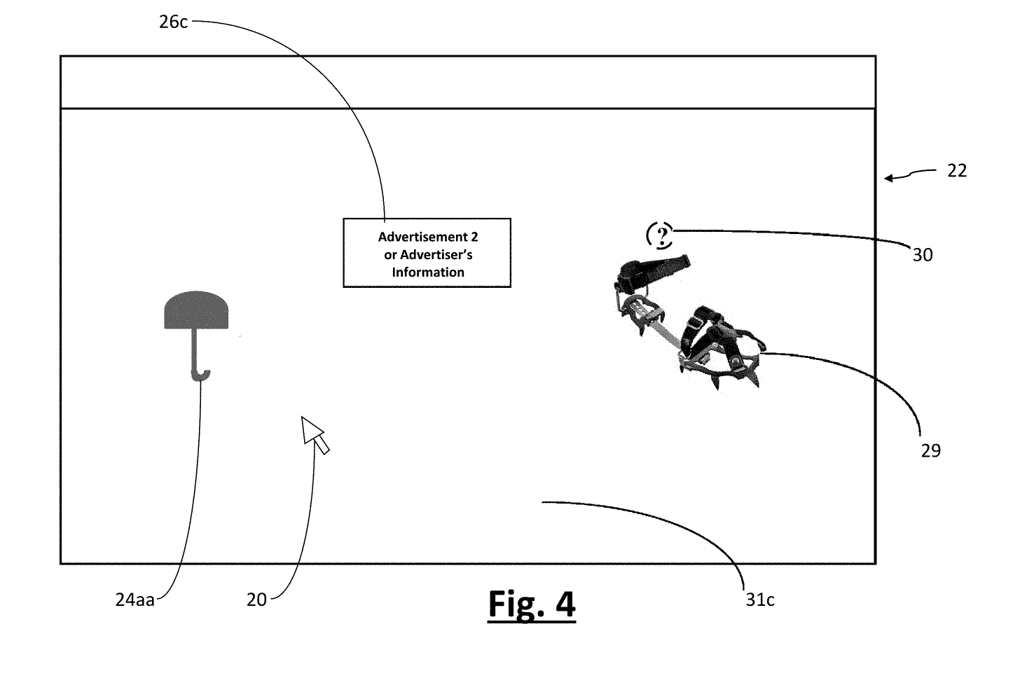

FIG. 4 shows after the first advertisement of FIG. 3 had concluded the first item of FIG. 2 had redisplayed.

After the advertisement ends, another option has some or all of the advertisement continues to run. Another option is to present the advertiser's identifying information that includes and is not limited to trademarks, other products or services, spokespersons, phone numbers, further contact information, associated website links, or a video of its theme park. FIG. 4 shows after the second advertisement of FIG. 3 had concluded, some or all of it continues to display or the advertiser's identifying information is displayed.

After the advertisement ends, another option is to present a different item to replace the concluded advertisement. FIG. 4 shows after the third advertisement of FIG. 3 had finished, a different sixth item had replaced the ad. Another option is to remove the concluded ad altogether. FIG. 4 shows an empty or blank space indicating the fourth advertisement of FIG. 3 had been removed.

In the first embodiment, advertisers gain a significant advantage. Since the user took the initiative to choose the item which then transforms into an advertisement, the advertiser gets the users' full and undivided attention.

### Description and Operation of Alternative Embodiments—FIGS. 1-3

The current application utilizes several alternative embodiments. An alternative embodiment operates when a preset, elapsed, extended, scheduled, programmed, predetermined, or pre-specified waiting time has passed, stopped, finished, or expired. The waiting time includes and is not limited to counting times, delayed periods, milliseconds, seconds, minutes, hours, days, dates, intervals, and durations. When or after the preset time expires the item transforms or morphs into an advertisement. This embodiment is particularly useful for computers with no access, no substantial access, or without constant access to an internet or a network. FIG. 3 shows at or after a preset time, the second and third items of FIG. 2 had transformed into an advertisement.

Another alternative embodiment is that the preset time is random or randomized. For example the random preset time can be any value from 0 to 2000 seconds. The random preset times includes and is not limited to randomized counting times, delayed periods, milliseconds, seconds, minutes, hours, days, dates, intervals, and durations. FIG. 3 shows at or after a random preset time, the fifth item of FIG. 2 had transformed into an advertisement. The random preset time can be repeated in a sequence of random preset times. The previous embodiment's preset time and the random preset times can be mixed, programmed, or shuffled in a sequence.

The previous two alternative embodiments are summed as follows: At or after a preset time or random preset time, any viewable item can transform into an advertisement, a sound only advertisement, or a touch advertisement. At or after a preset time or random preset time, a signal item representing a sound only item can transform into an advertisement, a sound only advertisement, or a touch advertisement. At or after a preset time or random preset time, a touch item can transform into an advertisement, a touch advertisement, or a sound only advertisement (not shown).

Another alternative embodiment is the first embodiment's user selection feature and the preset time or random preset time embodiments can be combined. The embodiment that operates first is the one that happens first. Either the user selection is first, or the preset time or random preset time expires first.

Another alternative embodiment is the first embodiment's user selection feature is separate and independent from the preset time and random preset time embodiments.

Another alternative embodiment is the item and its transformative process is in a fixed, constant position on the screen even if the pages of, for example, an ebook, digital magazine, website, or software application are turned, flipped over, pushed across, vanishes, slides, or jumps to another page (not shown).

Another alternative embodiment is the item and its transformative process can move around or switch to a different position on the screen. This can happen before, during, or after the user selection, preset time, or random preset time (not shown).

Another alternative embodiment is that the item is a non-advertising intellectual property or non-advertising marketing information. Examples include and are not limited to trademarks, copyrights, trade dress, logos, slogans, symbols, brand names, icons, marks, catchphrases, artwork, illustrated characters, background items, book illustrations, website layout parts or pieces, software application parts or images, phone numbers, addresses, links, words, text, website addresses, or other unique identifiers. For example, the item can be the U.S. Department of Transportation logo displayed on www.transportation.gov. FIG. 2 shows a fifth item that is a non-advertising intellectual property, trade dress, or marketing information item of “entityBRANDNAME”.

Another alternative embodiment is the item can partially show its advertisement. The item can show greater than 50% or less than 50% of its advertisement. For example, the item can be an animated tree swaying in the wind. A cluster of the tree's leaves partially shows its advertisement before the transformation into a complete advertisement. FIG. 2 shows the fifth item of “entityBRANDNAME” that partially shows its advertisement.

Another alternative embodiment is that the item is an advertising that transforms into another advertisement, either from the same advertiser or from a different advertiser. The advertising item can be, for example, text ads, image ads, moving image ads, commercials, or internet ads. An option is the advertising item is a part of an advertisement that transforms into the same, but complete advertisement. Thus the advertising item can be related to, runs on, continues to, makes a reference to, is connected to, or is a part of the same ad campaign as the after transformation advertisement (not shown).

An additional embodiment is the preset times or random preset times can be utilized in conjunction with creative counting methods. Examples of the counting methods includes and is not limited to sundials, animated heart beats, tick tocks, water drippings, disappearing or assembling necklace beads, disappearing or assembling jigsaw puzzle pieces, and a Victorian pocket watch (not shown).

There are immense creative and fun possibilities in executing variations of the theme of item transforms into an advertisement.

### CONCLUSION, RAMIFICATIONS, AND SCOPE

Accordingly, the reader will see a process that helps generate significant revenue from digital advertising in a unique and unexpected manner. A computer screen presents an item. For example, the start of a page has a large medieval style letter “S” that begins the phrase “She kicked hard in the cold perilous moat”. The “S” is the item. After a preset time of 200 seconds, the “S” transforms in any one of catchy, surprising, and fun ways into an advertisement. If a user selects the “S” before this preset time, the transformation happens earlier than the 200 seconds. The preset time can be separate and independent of the user selection.

The user who does not care for advertising will be spared from them for 200 seconds without having to do anything. Later the user is again spared, when the after transformation advertisement is finished, the “S” is redisplayed. As a result the screen's visual clutter is reduced. The redisplayed “S” is a welcome relief from the annoying, distracting prior art advertisings that are displayed right away.

Although the above description contains many specificities, these should not be construed as limiting the scope of the embodiments, but as merely providing exemplifications of some of the embodiments. Many other variations are possible. For example, the transformation shows the steps of outfitting a knight consisting of garments, paddings, chain mail, armor plates, and weapons.

Thus the scope of the embodiments should be determined by the appended claims and their legal equivalents, rather than by the examples given.

I claim:

1. A process, comprising:
a. providing a computer,
b. providing a screen of said computer,
c. implementing on said screen a non-advertising item,
d. utilizing a preset time, and
e. presenting said non-advertising item on said screen and at or after said preset time, said non-advertising item substantially transforms into an advertisement.

2. The process of claim 1 wherein said non-advertising item is a character, a word, an image, or a moving image.

3. The process of claim 1 wherein said non-advertising item is a non-advertising intellectual property, a non-advertising trade dress, or a non-advertising marketing information.

4. The process of claim 1 wherein said non-advertising item partially shows said advertisement.

5. The process of claim 1 wherein said preset time is a random preset time.

6. A digital method, comprising:
a. providing a screen,
b. implementing on said screen a non-advertising item, and
c. presenting said non-advertising item and when a user selects said non-advertising item said non-advertising item substantially morphs into an advertisement.

7. The digital method of claim 6 wherein said non-advertising item is a character, a word, an image, or a moving image.

8. The digital method of claim 6 wherein said non-advertising item is a non-advertising intellectual property, a non-advertising trade dress, or a non-advertising marketing information.

9. The digital method of claim 6 wherein said non-advertising item partially shows said advertisement.

10. The digital method of claim 6 wherein said preset time is a random preset time.

11. The digital method of claim 6 further including providing a computer.

12. A system, comprising:
providing a computer,
utilizing an item,
utilizing a preset time,
utilizing said computer to present said item and at or after said preset time, said item substantially transforms into an advertisement, and
whereby said transforms is meant to be entertaining, fun, or surprising.

13. The system of claim 12 wherein before said preset time expires a user selects said item, and said item substantially transforms into said advertisement.

14. The system of claim 12 wherein said preset time is replaced by a selection method and a user utilizes said selection method to choose said item, and said item substantially transforms into said advertisement.

15. The system of claim 12 wherein said item is a character, a word, an image, or a moving image.

16. The system of claim 12 wherein said item is an intellectual property, a trade dress, or a marketing information.

17. The system of claim 12 wherein said item partially shows said advertisement.

18. The system of claim 12 wherein said preset time is a random preset time.
